(19) United States
(12) Patent Application Publication
(10) Pub. No.: US 2004/0167844 A1
(43) Pub. Date: Aug. 26, 2004

(54) Method for payment of tuition and related college or university expenses

(76) Inventor: Patrick J. Dolan, Chesterfield, MO (US)

Correspondence Address: POLSTER, LIEDER, WOODRUFF & LUCCHESI, 12412 POWERSCOURT DRIVE SUITE 200, ST. LOUIS, MO, 63131-3615, US

(21) Appl. No.: 10/783,657

(22) Filed: Feb. 20, 2004

Related U.S. Application Data
(60) Provisional application No. 60/448,746, filed on Feb. 20, 2003.

(51) Int. Cl. G06F 17/60

(52) U.S. Cl. 705/36

(57) ABSTRACT

A method by which a beneficiary of a Section 529 account under the IRS code can quickly and conveniently pay tuition charges and fees at a college or university and purchase other education related items as well. The beneficiary is provided a debit card with account related information. The card can be used for point-of-sale, online, wire transfer, or telephone purchases of qualified items from qualified institutions or businesses. A database is maintained of all authorized institutions and businesses, and all authorized charges or purchases which can be made by the beneficiary using the card. Reports can then be readily generated for the beneficiary, benefactor, IRS, and others with sufficient detail to justify the charges or purchases made by the user.

### CROSS REFERENCE TO RELATED APPLICATIONS

This application claims priority from Provisional patent application serial number 60/448,746 filed Feb. 20, 2003 entitled “A METHOD FOR PAYMENT OF TUITION AND RELATED COLLEGE OR UNIVERSITY EXPENSES” which is incorporated by reference.

### STATEMENT REGARDING FEDERALLY SPONSORED RESEARCH OR DEVELOPMENT N/A

### BACKGROUND OF THE INVENTION

This invention relates to a method for electronically debiting transactions in an Internal Revenue Code, Section 529 investment account, a long term savings account (LSA), or a similar type account whose funds are used for the payment of qualified higher education expenses such as college or university tuition, fees, room and board, the cost of books, supplies, and equipment such as computers and the like required for a curriculum.

In 2001, Congress enacted legislation effecting Section 529 of the Internal Revenue Code. As currently written, this section makes contributions by an individual to a qualified state tuition program exempt from taxation. The State of Missouri has, for example, established such a program which is referred to as MOST. Under the MOST program, a benefactor (typically a child's parent or grandparent, but not limited to a relative) establishes an account and contributes assets or funds to it. Section 529 (c)(1)(B) of the Code states that the amount put into the account by a contributing benefactor for a designated beneficiary will not be included in the benefactor's gross income with respect to any distribution or earnings under the program. That is, no federal tax is due on money withdrawn from a 529 investment account, a long term savings account (LSA), or a similar type account whose funds are used for the payment of qualified higher education expenses if the money is used to pay for qualified and substantiated expenses incurred for the beneficiary's higher education. Currently, there are approximately 5 million accounts established under various qualified state plans with approximately $45 billion dollars invested in them. It is predicted that by 2010, there will be over 32 million accounts with an asset value of almost $390 billion.

A major problem with managing these programs and accounts is that present technology does not adequately address the qualification, substantiation, and accounting with respect to the accounts, nor the tax reporting that is required for purchases and payments of a beneficiaries' higher education expenses paid for with funds from a Section 529 investment account. First, the Internal Revenue Service (IRS) presently offers no guidance to the benefactor, consumer, investment manager, beneficiary, tax advisor, or accountant as to how to qualify or substantiate purchases made with funds from a 529 account for the benefit of the beneficiary. Second, state sponsored tuition reimbursement programs do not have a computer based system capable of handling the current number of accounts and their associated asset base, much less those which are estimated to soon be in place. The present technology does not provide the benefactor or beneficiary with the capability of electronically qualifying and substantiating such payments and purchases; and, particularly an automated accounting for such purchases by a state's tuition reimbursement program.

### BRIEF SUMMARY OF THE INVENTION

The invention provides a method of electronically qualifying, substantiating, and making payments for tuition, fees, room and board, as well as purchases for books, computers, and other necessary supplies from a qualifying account sanctioned by the IRS. The method employs a debit card unique to a beneficiary of an account. The debit card incorporates an electronic identification number and can be password protected for point-of-sale, on-line (Internet), wire transfers, and/or telephonic (audio or touch-tone) purchases. The method further includes a unique database of eligible educational institutions, and a unique database of qualified and substantiated items that may be purchased for a higher education. Under the method, an electronic record is made and maintained of all purchases and payments made using the debit card. The record is then used to generate those required for use by the IRS, the state, the benefactor, and beneficiary, as well as the educational institutions, and providers of qualified goods and services purchased using the debit card.

Other objects and features will be in part apparent and in part pointed out hereinafter.

### DETAILED DESCRIPTION OF INVENTION

The following detailed description illustrates the invention by way of example and not by way of limitation. This description will clearly enable one skilled in the art to make and use the invention, and describes several embodiments, adaptations, variations, alternatives and uses of the invention, including what I presently believe is the best mode of carrying out the invention. As various changes could be made in the above constructions without departing from the scope of the invention, it is intended that all matter contained in the following description shall be interpreted as illustrative and not in a limiting sense.

In accordance with the present invention, a method is provided for facilitating electronic debit transactions for a Section 529 investment account, a long term savings account (LSA), or any other qualifying account whose funds may be used for the purchase and payment of qualified and substantiated higher education expenses. As noted above, these expenses typically include tuition and incidental fees, dormitory room and board, and the cost of books, supplies and other equipment. In accordance with a Section 529 qualified state program, a benefactor will have contributed money, funds or assets into an account, and this amount will usually be increased based upon an investment strategy used by the contributing benefactor. Thus, when the beneficiary is ready for college and begins incurring the various expenses, funds are already available in the account to meet them.

With respect to expenses, before items can be legitimately expensed against the account, the various types of expenses must be qualified so that, if subsequently questioned by the IRS, the expense can be justified. In current systems which rely primarily on a paper trail (printed receipts, etc.) used by the state sponsored tuition reimbursement programs, this may not be always easy to accomplish because of the vast amount of paperwork which is required, and the fact that receipts and/or transaction records get misplaced or lost, numbers are transcribed incorrectly, etc. Further, there may be questions as to what is an acceptable or qualified transaction and what is not. If the student does not want to stay in a dormitory, for example, but a fraternity or sorority house, or rooming house, can that expense be justified under whatever state qualification guidelines are in effect.

When a beneficiary of a 529 account is ready to begin his or her higher education, a debit card is provided to them. The functionality of the debit card can be controlled and limited in use by the benefactor of the account. A central database is established and includes information as to who is issued a card and which account or accounts with which the debit card can be used. Next, each college or university participating in the system is entered into the database along with their current tuition and fees charged to students. Such tuition and fees will have its own unique electronic code number or identifier. These are Eligible Educational Institutions as defined under Section 529 of the Code, and are generally known as accredited post-secondary educational institutions offering credit toward a bachelor's degree, an associate's degree, a graduate level or professional degree, or another recognized post-secondary credential. Further, each item entered in the database will have its own unique electronic code number or identifier. These are then used to facilitate qualification and substantiation of the electronic debit transactions for the 529 accounts, LSA's, or a similar type account whose funds are used for the payment of qualified higher education expenses.

On- or Off-Campus bookstores, dormitories, cafeterias, libraries, gymnasiums, etc. are also entered into the database, along with their current fee structures. This allows the student to stay in the dorm, eat at the cafeteria, buy books and note paper at the college bookstore, make copies at its library, and buy clothes for his/her gym class all with the same card. Similarly, if an on-line bookstore offers the student's class books, he or she can buy them that way as well using the debit card. If an off-campus rooming house, bookstore or library is used by the student for education related purposes, that institution, merchant, or vendor can also be approved for inclusion in the database so the card can be used for purchases or services at that place of business as well.

When used, the student presents his or her card at the point-of-purchase. Access to the database may be password protected so the user, in addition to presenting the card, may also have to provide a personal identification number (PIN) or authorization code or password when engaging in a qualified transaction. The method includes an electronic qualification and substantiation system for each transaction made by the beneficiary of a 529 account, LSA or a similar type account whose funds are used for the payment of qualified higher education expenses. The method incorporates not only use of the debit card at a point-of-purchase, but also internet/on-line transactions, wire transfers, and telephone transactions either by voice or by touch tone.

As the debit card is used, for each beneficiary, a record is maintained in the database for all the tuition and fees paid, and the specific goods, products, and services purchased from approved institutions or businesses with the card by the beneficiary. The record includes such information as who is the beneficiary using the card, which account or accounts the beneficiary is using, when the card was used, the purpose for which it was used, the amount of the purchase, the institution, vendor or merchant, the time and place of the purchase, etc. This information is then available to the beneficiary, the benefactor, the IRS, the state agency administering the program, the college or university to which the tuition and fees were paid, bookstores or other merchants selling qualified, or deemed needed, goods and services for a higher education. Since the information is contained in substantial detail, all, or appropriate portions of it can be provided to each report recipient depending upon the purposes for which the report is to be used. The records are available in summary form (how much was spent on tuition and fees over an academic year), or in detail form. Such information is needed to substantiate data submitted by the beneficiary to the IRS on tax form 1099-Q.

Besides the foregoing, the database can be used by state and federal government agencies such as the Department of Education to elicit pertinent information about our system of higher education. In addition, third parties such as book vendors could use the database to determine how many books printed by a particular publisher, for example, were sold over a given time, in a particular area, for what prices. Other kinds of similar information would also be available, or can be generated by the system.

To defray the cost of the system, a beneficiary could be charged a fee (one-time or annual) for the debit card. The colleges and universities could also be charged a similar fee, as could vendors qualified to be in the system. Fees are charged for certain, non-taxpayer or non-governmental reports. It is important to note that a major reason why institutions, and various businesses will want to be qualified in the program and included in the database, is that the accounts are funded prior to the beneficiary using them. Thus, the purchases made by the beneficiary with the debit card are paid for with immediately available funds versus purchases made by a credit card or other debt-generating mode of transaction.

In view of the above, it will be seen that the several objects and advantages of the present invention have been achieved and other advantageous results have been obtained.

Having thus described the invention, what is claimed and desired to be secured by Letters Patent is:

1. A method of paying tuition and related college or university expenses comprising:
establishing and funding a Section 529 investment account in accordance with Internal Revenue Service rules and regulations, the account being established for a named benefactor;
identifying those tuition and related education expenses which can be paid from funds in the Section 529 investment account;
providing the benefactor a debit card usable by the benefactor to pay the tuition and related education expenses as they arise; and,
debiting the investment account by the amounts paid using the debit card.

2. The method of claim 1 wherein identifying those tuition and related expenses which can be paid from investment account funds includes identifying both on-campus and off-campus facilities at which purchases may be made using the debit card, and identifying the types of expenses which can be paid for at those facilities using the card.

3. The method of claim 2 further including pre-approving the expenses which can be paid for using the debit card prior to the benefactor using the debit card to pay for expenses incurred at those facilities.

4. The method of claim 3 including establishing a central database for all colleges and universities, and on-campus and off-campus facilities at those institutions which are approved for use with the investment account, so any benefactor of a Section 529 investment account can use their debit card at those institutions and facilities.

5. The method of claim 1 further including recording of those expenses paid for by the benefactor using their debit card, subtracting those expenses from the amount in the investment account, and providing a record of the expenses and the balance remaining in the account.

6. The method of claim 1 in which the benefactor must use a personal identification number or authorization code each time an expense is paid for using the debit card, so to protect the benefactor and the account.

7. The method of claim 1 in which the debit card is usable for point-of-purchase transactions.

8. The method of claim 8 in which the debit card is further usable for wire transfers, telephonic transactions, and internet transactions.

9. The method of claim 1 further including charging the benefactor a fee for use of the debit card.

10. The method of claim 2 further including charging colleges, universities, and the on-campus and off-campus facilities a fee for inclusion in a database of approved sites where the debit card can be used.
